(19) United States
(12) Patent Application Publication
(10) Pub. No.: US 2018/0012296 A1
(43) Pub. Date: Jan. 11, 2018

(54) METHODS AND SYSTEMS FOR OFFERING A CREDIT CARD ACCOUNT TO A CONSUMER AT A POINT-OF-SALE LOCATION

(71) Applicant: CAPITAL ONE FINANCIAL CORPORATION, MCLEAN, VA (US)

(72) Inventors: Charles A. Rosenblatt, Richmond, VA (US); Jack M. Forestell, Richmond, VA (US)

(21) Appl. No.: 15/712,803

(22) Filed: Sep. 22, 2017

Related U.S. Application Data
(62) Division of application No. 10/729,997, filed on Dec. 9, 2003.

(51) Int. Cl. G06Q 40/02; G06Q 20/10

(52) U.S. Cl. CPC G06Q 40/02; G06Q 20/10

(57) ABSTRACT

Systems and methods are disclosed for offering a credit card account to a consumer at a point-of-sale location. The systems and methods may include offering a product to the consumer at the point-of-sale location. In addition, the systems and methods may include offering a credit card account to the consumer at the point-of-sale location. Moreover, the product offer may be conditioned based on the consumer's acceptance of the credit card account, fees allocating charges associated with the product may be required to be charged to the credit card account. The fees allocating charges associated with the product may comprise periodic subscription fees associated with the product's use.

### BACKGROUND OF THE INVENTION

### I. Field of the Invention

The present invention generally relates to offering a credit card account. More particularly, the present invention relates to methods and systems for offering a credit card account to a consumer at a point-of-sale location.

### II. Background Information

Credit card products have become so universally well known and ubiquitous that they have fundamentally changed the manner in which financial transactions and dealings are viewed and conducted in society today. Credit card products are most commonly represented by plastic card-like members that are offered and provided to consumers through credit card issuers (such as banks and other financial institutions). With a credit card, an authorized consumer is capable of purchasing services and/or merchandise without an immediate, direct exchange of cash.

With present credit processing systems, the consumer presents a credit card or credit card number to a merchant. The merchant processes and transmits information, including credit card information and purchase amount, through an established system of electronic clearances and settlements to complete payment. The card issuer is notified of the pending transaction and is given an opportunity to approve it. If approved, a series of clearances and settlements among interchange participants (namely, the merchant, the acquiring bank, the card issuer, and/or the processing institution) results in the card issuer reimbursing the other participants in the process for the cost of the purchase. The card issuer then invoices the consumer for the amount of the purchase and may extend credit such that the consumer can pay the amount of the purchase over time.

In general, the card issuer provides the consumer with a monthly or otherwise periodic statement. The consumer may have the option to either fully pay the outstanding balance, or as a matter of necessity or choice, may defer at least a portion of the balance for later payment with accompanying interest or finance charges for the period during which payment of the outstanding debt is deferred. Following receipt of the statement, the consumer generally mails a check or money order to the card issuer.

Because of the credit background checking and because of the streamline payment process, merchants offering products for sale often prefer consumers to pay by credit card. For example, a merchant may be more willing to sell a product to a consumer if the consumer is willing to pay for the product with a credit card. However, if the consumer does not have a credit card, the merchant is usually not able to offer the consumer a credit card. Moreover, if periodic or future subscription fee payments are to be collected from the consumer, the merchant may not be able to bill such fees to a credit card.

In view of the foregoing, there is presently a need for an improved system and method for marketing a credit card account to a consumer. Further, there is a need for a system and method for offering a credit card account to a consumer at a point-of-sale location. For example, a need exists for offering a credit card account to a consumer at a point-of-sale location to pay subscription fees associated with a product to be purchased.

### SUMMARY OF THE INVENTION

Consistent with embodiments of the present invention, systems and methods are disclosed for efficiently offering a credit card account to a consumer at a point-of-sale location.

In accordance with one embodiment, a method for marketing a credit card account to a consumer comprises receiving an application for the credit card account from the consumer through a point-of-sale location, receiving a notification that the consumer requests to purchase a product at the point-of-sale location, and determining whether to approve the application based upon receiving the notification that the consumer requests to purchase the product.

According to another embodiment, a method for offering a credit card account to a consumer at a point-of-sale location comprises offering a product to the consumer at the point-of-sale location, offering a credit card account to the consumer at the point-of-sale location, and conditioning the offer of the product to the consumer based on the consumer's acceptance of the credit card account, fees allocating charges associated with the product being required to be charged to the credit card account.

In accordance with yet another embodiment, a system for marketing a credit card account to a consumer comprises a memory storage for maintaining a database and a processing unit coupled to the memory storage, wherein the processing unit is operative to receive an application for the credit card account from the consumer through a point-of-sale location, receive a notification that the consumer requests to purchase a product at the point-of-sale location, and determine whether to approve the application based upon receiving the notification that the consumer requests to purchase the product.

In accordance with yet another embodiment, a system for offering a credit card account to a consumer at a point-of-sale location comprises a component for offering a product to the consumer at the point-of-sale location, a component for offering a credit card account to the consumer at the point-of-sale location, and a component for conditioning the offer of the product to the consumer based on the consumer's acceptance of the credit card account, fees allocating charges associated with the product being required to be charged to the credit card account.

In accordance with yet another embodiment, a computer-readable medium comprising a set of instructions which when executed perform a method for marketing a credit card account to a consumer, the method comprising receiving an application for the credit card account from the consumer through a point-of-sale location, receiving a notification that the consumer requests to purchase a product at the point-of-sale location, and determining whether to approve the application based upon receiving the notification that the consumer requests to purchase the product.

In accordance with yet another embodiment, a computer-readable medium comprising a set of instructions which when executed perform a method for offering a credit card account to a consumer at a point-of-sale location, the method comprising offering a product to the consumer at the point-of-sale location, offering a credit card account to the consumer at the point-of-sale location, and conditioning the offer of the product to the consumer based on the consumer's acceptance of the credit card account, fees allocating charges associated with the product being required to be charged to the credit card account.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary credit card offering system consistent with an embodiment of the present invention;

FIG. 2 is a flow chart of an exemplary method for marketing a credit card account to a consumer consistent with an embodiment of the present invention; and

FIG. 3 is a flow chart of an exemplary method for offering a credit card account to a consumer at a point-of-sale location consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with the invention may offer a credit card account to a consumer at a point-of-sale (POS) location. Consistent with the inventions, a credit card may be offered as part of a purchase for a subscription product, for example, such as a cellular telephone. The product, however, may comprise any product or service and is not limited to cellular telephones or cellular telephone service. The credit card account may be offered at a POS terminal. The consumer may then be told that the credit card would be used for making the monthly subscription payments for the purchased product, for example, the cellular telephone. The subscription fee may automatically appear on the monthly credit card bill, for example.

Consequently, a merchant may be more willing to sell a product to a consumer if the consumer is willing to pay for the product with a credit card. However, if the consumer does not have a credit card, the merchant is usually not able to offer the consumer a credit card. Moreover, if periodic or future subscription fee payments are to be collected from the consumer, the merchant may not be able to bill such fees to a credit card. This is especially true when periodic or future subscription fee payments are to be collected from the consumer. If the merchant can bill subscription fees to a credit card, the merchant may be more confident and, therefore, more willing to sell a product or offer a service to the consumer. However, if the consumer does not have a credit card account, the merchant risks loosing a sale by requiring a credit card account for charging subscription fees

Consistent with the invention, the system may have more applicability for consumers who are initially turned down for a product, such as a cellular telephone, because of poor credit. Consistent with the invention, the turned down consumer may be able to purchase the product and the service subscription if they agree to have the monthly charges automatically placed on the credit card. If they agree, an application for the credit cards may be processed at a POS terminal.

An embodiment consistent with the invention may comprise a system for marketing a credit card account to a consumer. The system may comprise a memory storage for maintaining a database and a processing unit coupled to the memory storage wherein the processing unit is operative to receive an application for the credit card account from the consumer through a point-of-sale location. The processing unit may be further operative to receive a notification that the consumer requests to purchase a product at the point-of-sale location. Furthermore the processing unit may be further operative to determine whether to approve the application based upon receiving the notification that the consumer requests to purchase the product.

Another embodiment consistent with the invention may comprise a system for offering a credit card account to a consumer at a point-of-sale location. The system may comprise a component for offering a product to the consumer at the point-of-sale location and a component for offering a credit card account to the consumer at the point-of-sale location. Furthermore, the system may comprise a component for conditioning the offer of the product to the consumer based on the consumer's acceptance of the credit card account, and allocating charges associated with the product to the credit card account.

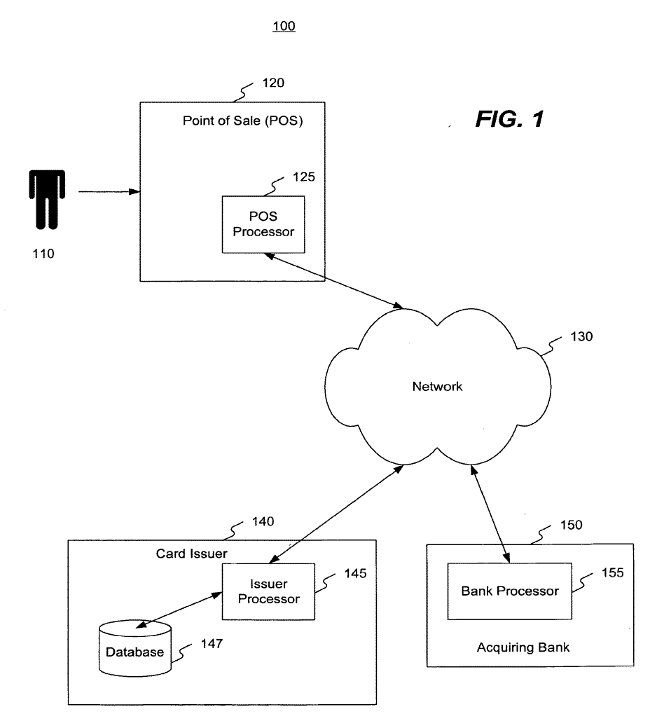

Consistent with an embodiment of the present invention, the aforementioned memory, processing unit, and components may be implemented in a credit card offering system, such as the exemplary credit card offering system 100 of FIG. 1. Any suitable combination of hardware, software and/or firmware may be used to implement the memory, processing unit, or components. By way of example, the memory, processing unit, or components may be implemented with any of an issuer processor 145, a point-of-sale (POS) processor 125, or a bank processor 155, in combination with system 100. The aforementioned system and processors are exemplary and other systems and processors may comprise the aforementioned memory, processing unit, or components, consistent with embodiments of the present invention.

By way of a non-limiting example, FIG. 1 illustrates system 100 in which the features and principles of the present invention may be implemented. As illustrated in the block diagram of FIG. 1, system 100 may include a consumer 110, a POS location 120, a network 130, a card issuer 140, and an acquiring bank 150. Consumer 110 may be an individual, for example, desiring to purchase a product at POS 120 and desiring to open a credit card account for the purchase, but may also be an organization or other entity having such desires. Consumer 110 may interact with the POS location 120 to purchase the product and/or open a credit card account.

POS location 120 may include any merchant connected to network 130. For example, POS location 120 may include retail stores, service providers, ATM machines, or any other business that is equipped to accept credit card transactions. POS location 120 further includes POS processor 125 used to obtain, for example, credit or transaction information from consumer 110 and to transmit that information to other entities connected to network 130. In systems consistent with the present invention, POS 120 may be used to offer a product to consumer 110, offer a credit card account to consumer 110, or to receive payments to the outstanding balance of a credit card account of consumer 110. POS location 120 may be connected to card issuer 140 and acquiring bank 150 through network 130. Network 130 may include any data network, such as, for example, an existing secure credit network, a local area network (LAN), a public telephone switching network,-an automated clearing house (ACH) network, or a wide area network, such as the Internet.

Card issuer 140 may be a bank, financial institution, or any other organization that provides a credit card to consumer 110. Card issuer 140 may further includes issuer processor 145 and a database 147. Issuer processor 145 may verify and process credit applications and transactions for credit cards issued by card issuer 140. Database 147 may contain account information, such as identifying data and account balance, for each consumer having a credit card issued by card issuer 140. Card issuer 140 may receive request from POS location 120 to verify and initiate credit card transactions including the creation of new credit card accounts.

For example, in a typical purchase-for-credit transaction, consumer 110 presents a credit card issued by card issuer 140 to purchase goods or services at POS location 120. POS processor 125 gathers credit account information and generates a request for a transaction. POS processor 125 then sends this request through network 130 to card issuer 140, where the request is received by issuer processor 145. Issuer processor 145 accesses database 147 to verify data about the status of the credit account of consumer 110. Based on the accessed information, issuer processor 145 then may approve the requested transaction based on that data. Issuer processor 145 acknowledges any approval or denial by sending a message through network 130 back to POS processor 125.

Furthermore, system 100 may be used to create a new credit card account for consumer 110. For example, data corresponding to consumer 110 may be collected and stored in database 147. This data may include information about consumer 110 sufficient to perform a consumer credit analysis. The data may be collected from consumer 110 through point-of-sale location 120, transmitted through network 130 to card issuer 140 where it may be stored in database 147. Moreover, the data may include data from a credit reporting bureau (not shown) or data corresponding to consumer 110 that is not credit related. Issuer processor 145 may perform a consumer credit analysis using at least the data to determine whether to approve a credit card account for consumer 110.

Acquiring financial institution 150 may be any financial institution, such as a bank, connected to network 130. Most POS locations 120 do not interact with the card issuer directly to handle many of the operations required to complete a credit card transaction; thus, POS location 120 contracts with acquiring bank 150 for these tasks. For example, acquiring bank 150 may facilitate the clearance and settlement of receipts and funds between the POS location 120 and the card issuer 140 by receiving receipts, reimbursing POS location 120 for the amount of the transactions, and then seeking reimbursement from card issuer 140. Acquiring bank 150 may receive receipts from POS location 120 for each transaction. Acquiring bank 150 may then provide accounting services with respect to these transactions. For example, acquiring bank 150 may receive receipts indicating purchases made at POS location 120, for which funds should be transferred from card issuer 140 to POS location 120. Acquiring bank 150 may also receive receipts indicating fund transfers made at POS location 120, for which funds should be transferred from POS location 120 to card issuer 140. Acquiring bank 150 then may aggregate all of these transactions and provide a grand total to be transferred from card issuer 140 to POS location 120, or vice versa. Acquiring bank 150 includes bank processor 155 for handling these transactions. Alternatively, POS location 120 and card issuer 140 may complete transactions directly, without the use of acquiring bank 150.

Issuer processor 145, POS processor 125, or bank processor 155 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 130 may comprise, for example, a local area network (LAN) or a wide area network (WAN). Such networking environments are commonplace in offices, enterprise-wide computer networks, intranets, and the Internet, and are known by those skilled in the art. When a LAN is used as network 130, a network interface located at any of the processors may be used to interconnect any of the processors. When network 130 is implemented in a WAN networking environment, such as the Internet, the processors may typically include an internal or external modem (not shown) or other means for establishing communications over the WAN. Further, in utilizing network 130, data sent over network 130 may be encrypted to insure data security by using known encryption/decryption techniques.

In addition to utilizing a wire line communications system as network 130, a wireless communications system, or a combination of wire line and wireless may be utilized as network 130 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit inventory data or other types of data by methods and processes other than, or in combination with, network 130. These methods and processes may include, but are not limited to, transferring data via, diskette, CD ROM, facsimile, conventional mail, an interactive voice response system-(IVR), or via voice over a publicly switched telephone network.

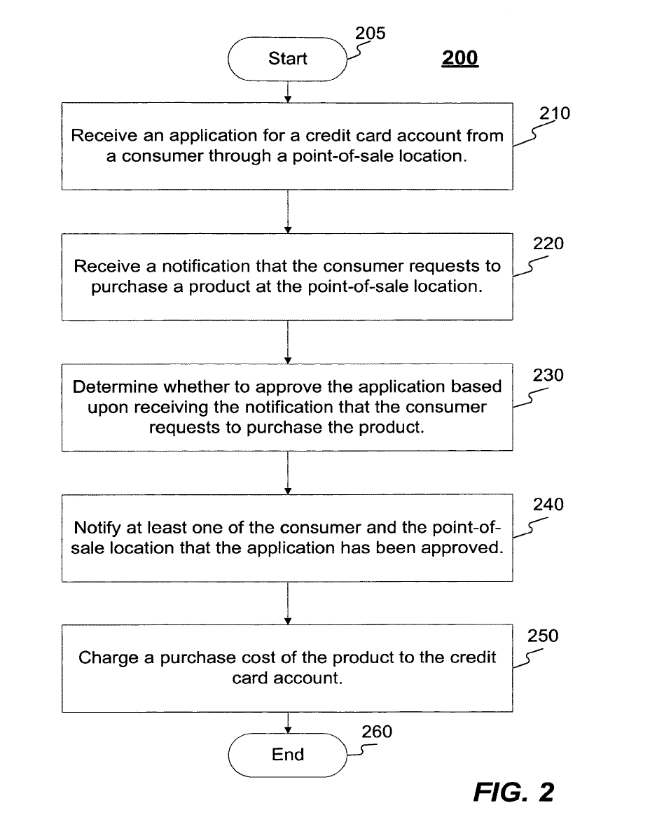

FIG. 2 is a flow chart setting forth the general stages involved in exemplary method for marketing a credit card account to a consumer consistent with the invention. Exemplary ways to implement the stages of method 200 will be described in greater detail below. Exemplary method 200 may begin at starting block 205 and proceeds to stage 210 where issuer processor 145 may receive an application for a credit card account from consumer 110 from point-of-sale location 120. For example, consumer 110 may wish to purchase a product, for example, a cellular telephone, at point-of-sale location 120. Due to the consumer's poor credit history or other information, for example, a merchant operating point-of-sale location 120 may consider the transaction too risky, and may not wish to sell the product to consumer 110. For example, the merchant may believe that consumer 110 may not pay or may have trouble paying periodic subscription fees associated with the product. If the product comprises a cellular telephone, the periodic subscription fees may comprise a monthly fee associated with service for the cellular telephone. However, if consumer 110 possessed a credit card account that subscription fees may be charged to, the merchant may be willing to sell the product to consumer 110. Because of this, the merchant may cause point of sale location 120 to obtain a credit card application from consumer 110 and pass the credit card application from POS processor 125, through network 130, to issuer processor 145. The credit card application may include information about consumer 110 sufficient to perform a consumer credit analysis of consumer 110. Furthermore, receiving the application at issuer processor 145, for example, may constitute receiving a notification that consumer 110 requests to purchase the product.

From stage 210, where issuer processor 145 may receive the application for the credit card account from consumer 110 through point-of-sale location 120, exemplary method 200 may continue to stage 220 where issuer processor 145 may receive a notification that consumer 110 requests to purchase the product at point-of-sale location 120. For example, once consumer 110 decides to purchase the product, the merchant may cause POS processor 125 to generate the notification, send it through network 130, to issuer processor 145. Issuer processor 145 receiving the notification notifies the credit card issuer that consumer 110 requests to purchase the product. Moreover, the notification and the application may be received by issuer processor 145 separately or together. The application may already be located at point-of-sale location 120 for use by consumer 110 or may be sent from issuer processor 145.

Exemplary method 200 may then advance to stage 230 where issuer processor 145 determines whether to approve the application. Approval of the application may be based upon, for example, receiving the notification that consumer 110 requests to purchase the product. For example, because one reason for providing the credit card account to consumer 110 may be to provide a structure through which consumer 110 may pay subscription fees associated with the product, the credit card issuer may not wish to issue the credit card account to consumer 110 unless the credit card issuer has notice that consumer 110 requests to purchase the product. Accordingly, issuer processor 145 may deny the application if consumer 110 does not manifest an intent or agree to purchase the product. Notwithstanding, issuer processor 145 may approve the application even though consumer 110 does not purchase the product.

After issuer processor 145 determines whether to approve the application based upon receiving the notification that consumer 110 requests to purchase the product in stage 230, exemplary method 200 may continue to stage 240 where issuer processor 145 may notify consumer 110, point-of-sale location 120, or both that the application has been approved. For example, issuer processor 145 may send a message to POS processor 125, through network 125, that the application has been approved. The message may in turn be given to consumer 110 at POS processor 125.

Moreover, issuer processor 145 may notify or directly cause point-of-sale location 120 to prevent the consumer's purchase of the product if the application is not approved. For example, if issuer processor 145 does not approve the application, issuer processor 145 may send a signal through network 130 to POS processor 125. The signal may provide a message instructing the merchant not to sell the product to consumer 110, or the signal may directly cause the POS processor to not carry out a sales transaction of the product to consumer 110.

Upon the application's approval and based upon the notification that consumer 110 requests to purchase the product, issuer processor 145 may then charge fees associated with the product to the credit card account. The charged fees may correspond to service fees charged to the credit card account during subsequent statement cycles or they correspond to the consumer's usage of the purchased product. For example, the charged fees may correspond to at least one function of the product resulting in a reoccurring payment. Product functions may comprises, but are not limited to cellular telephone service, pager service, instant messaging service, or internet service. Notwithstanding, the credit card account may be used in subsequent purchase transactions unrelated to the product.

Furthermore, issuer processor 145 may cause the function to be inoperable if, for example, the credit card account is closed or delinquent. For example, if the product comprises a cellular telephone, issuer processor 145 may send a signal to a cellular telephone service provider providing service to consumer 110's cellular telephone. The signal may inform the cellular telephone service provider to discontinue cellular telephone service because consumer 110 failed to pay a credit card bill associated with service fees for the cellular telephone service.

From stage 240, where issuer processor 145 notifies consumer 110, point-of-sale location 120, or both that the application has been approved, exemplary method 200 may continue to stage 250 where issuer processor 145 may charge a purchase cost of the product to the credit card account. For example, POS 125 may complete the product sale to consumer 110 and notify issuer processor 145 to charge consumer 110's credit card for the product's cost. Notwithstanding, the credit card may be used for purchases other than or in addition to the product. Furthermore, in addition to point-of-sale location 120, the credit card account may be used in commerce anywhere where it is accepted. From stage 250 where issuer processor 145 charges the purchase cost of the product to the credit card account, exemplary method 200 ends at stage 260.

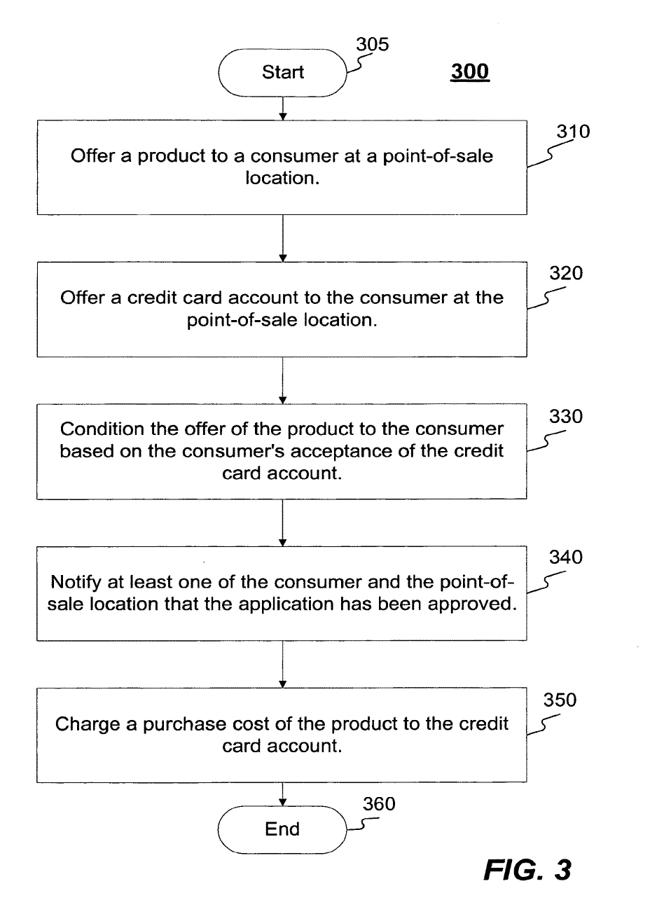

FIG. 3 is a flow chart setting forth the general stages involved in an alternative exemplary method for offering a credit card account to a consumer at a point-of-sale location consistent with the invention. Exemplary ways to implement the stages of method 300 will be described in greater detail below. Exemplary method 300 may begin at starting block 305 and proceeds to stage 310 where POS processor 125 may offer a product to consumer 110 at point-of-sale location 120. For example, consumer 110 may wish to purchase a product, for example, a cellular telephone, at point-of-sale location 120. Accordingly, a merchant operating POS processor 125 may offer to sell the cellular telephone to consumer 110 at point-of-sale location 120.

From stage 310, the merchant offers the product to consumer 110 at point-of-sale location 120, exemplary method 300 may continue to stage 320 where issuer processor 145 may offer a credit card account to consumer 110 at point-of-sale location 120. For example, issuer processor 145 may send a message offering the credit card through network 130 to consumer 110 at point of sale 120. In response, consumer 110 may provide information comprising an application for the credit card. The application may be sent through network 130 and may be received by issuer processor 145. The application may already be located at point-of-sale location 120 for use by consumer 110 or may be sent from issuer processor 145. The credit card application may include information about consumer 110 sufficient to perform a consumer credit analysis of consumer 110 by issuer processor 145.

Exemplary method 300 may then advance to stage 330 where the merchant may condition the offer of the product to consumer 110 based on the consumer's acceptance of the credit card account. For example, the merchant may explain to consumer 110 that the merchant may only sell the product to consumer 110 if consumer 110 agrees to accept the credit card and have period fees such as subscription fees associated with the product charged to the credit card. Due to the consumer's poor credit history or other information, for example, a merchant operating point-of-sale location 120 may consider the transaction too risky, and may not wish to sell the product to consumer 110. For example, the merchant may believe that consumer 110 may not pay periodic subscription fees associated with the product. If the product comprises a cellular telephone, the periodic subscription fees may comprise a monthly fee associated with service for the cellular telephone. However, if consumer 110 possessed a credit card account that subscription fees may be charged to, the merchant may be willing to sell the product to consumer 110.

After the merchant conditions the offer of the product to consumer 110 based on the consumer's acceptance of the credit card account in stage 330, exemplary method 300 continues to stage 340 where issuer processor 145 notifies consumer 110, point-of-sale location 120, or both that the application has been approved. For example, issuer processor 145 may send a message to POS processor 125, through network 125, that the application has been approved. The message may in turn be given to consumer 110 at POS processor 125.

From stage 340, where issuer processor 145 may notify consumer 110, point-of-sale location 120, or both that the application has been approved, exemplary method 300 may continue to stage 350 where issuer processor 145 may charge a purchase cost of the product to the credit card account. For example, upon the application's approval and based upon the notification that consumer 110 requests to purchase the product, issuer processor 145 may charge fees associated with the product to the credit card account. The charged fees may correspond to service fees charged to the credit card account during subsequent statement cycles or they may correspond to the consumer's usage of the purchased product. Particularly, the charged fees may correspond to at least one function of the product. Product functions may comprises, but are not limited to cellular telephone service, pager service, instant messaging service, or internet service. Notwithstanding, the credit card account may be used in subsequent purchase transactions unrelated to the product.

Furthermore, issuer processor 145 may cause the function to be discontinued if, for example, the credit card account is closed or delinquent. For example, if the product comprises a cellular telephone, issuer processor 145 may send a signal to a cellular telephone service provider providing service to consumer 110's cellular telephone. The signal may inform the cellular telephone service provider to discontinued service because consumer 110 failed to pay a credit card bill associated with service fees for the cellular telephone service. From stage 350 where issuer processor 145 may charge the purchase cost of the product to the credit card account, exemplary method 300 may end at stage 360.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1-20. (canceled)

21. A method for controlling operability of a product associated with a credit card account, the method comprising:
receiving an application for a credit card account, the application being associated with a consumer at a point-of-sale location for purchase of a product offered at the point-of-sale location;
determining that the consumer has a credit rating below a predetermined threshold;
approving the application for the credit card account for purchase of the product conditioned upon the consumer's acceptance of the credit card account, fees associated with the product being charged to the credit card account, and at least one function of the product being operable based on the status of the credit card account;
determining that a credit card account created responsive to the consumer's acceptance is at least one of closed or delinquent; and
generating a signal configured to disable the at least one function of the product based on the determination that the credit card account is closed or delinquent.

22. (canceled)

23. The method of claim 22, further comprising notifying at least one of the consumer and the point-of-sale location that the application has been approved.

24. (canceled)

25. The method of claim 21, wherein the credit card account is configured for use in subsequent purchase transactions unrelated to the product.

26. (canceled)

27. (canceled)

28. The method of claim 21, wherein the charged fees correspond to the consumer's usage of the purchased product.

29. (canceled)

30. The method of claim 21, wherein the at least one function comprises at least one of cellular telephone service, pager service, instant messaging service, and internet service.

31-51. (canceled)

52. A system for controlling operability of a product associated with a credit card account, the system comprising:
a memory having instructions stored therein; and
one or more processors configured to execute the instructions to perform a method comprising:
receiving an application for a credit card account, the application being associated with a consumer at a point-of-sale location for purchase of a product offered at the point-of-sale location;
determining that the consumer has a credit rating below a predetermined threshold;
approving the application for the credit card account for purchase of the product conditioned upon the consumer's acceptance of the credit card account fees associated with the product being charged to the credit card account, and at least one function of the product being operable based on the status of the credit card account;
determining that a credit card account created responsive to the consumer's acceptance is at least one of closed or delinquent; and
generating a signal configured to disable the at least one function of the product based on the determination that the credit card account is closed or delinquent.

53. (canceled)

54. The system of claim 53, further comprising notifying at least one of the consumer and the point-of-sale location that the application has been approved.

55. (canceled)

56. The system of claim 52, wherein the credit card account is configured for use in subsequent purchase transactions unrelated to the product.

57. (canceled)

58. (canceled)

59. The system of claim 52, wherein the charged fees correspond to the consumer's usage of the purchased product.

60. (canceled)

61. The system of claim 52, wherein the at least one function comprises at least one of cellular telephone service, pager service, instant messaging service, and internet service.

62-82. (canceled)

83. A computer-readable medium comprising a set of instructions which when executed perform a method for controlling operability of a product associated with a credit card account, the method comprising:
receiving an application for a credit card account, the application being associated with a consumer at a point-of-sale location for purchase of a product offered at the point-of-sale location;
determining that the consumer has a credit rating below a predetermined threshold;
approving the application for the credit card account for purchase of the product conditioned upon the consumer's acceptance of the credit card account fees associated with the product being charged to the credit card account, and at least one function of the product being operable based on the status of the credit card account;
determining that a credit card account created responsive to the consumer's acceptance is at least one of closed or delinquent; and
generating a signal configured to disable the at least one function of the product based on the determination that the credit card account is closed or delinquent.

84. (canceled)

85. The computer-readable medium of claim 84, the method further comprising notifying at least one of the consumer and the point-of-sale location that the application has been approved.

86. (canceled)

87. The computer-readable medium of claim 83, wherein the credit card account is configured for use in subsequent purchase transactions unrelated to the product.

88. (canceled)

89. (canceled)

90. The computer-readable medium of claim 83, wherein the charged fees correspond to the consumer's usage of the purchased product.

91. (canceled)

92. The computer-readable medium of claim 83, wherein the at least one function comprises at least one of cellular telephone service, pager service, instant messaging service, and internet service.

93. (canceled)

94. The method of claim 21, further comprising sending the signal to an issuer processor thereby instructing the issuer processor to disable the at least one function of the product; and
sending a signal from the issuer processor to a cellular telephone service provider providing cellular telephone service to the product, wherein the product is a cellular telephone.

95. The method of claim 94, wherein the signal from the issuer processor instructs the cellular telephone service provider to discontinue cellular telephone service to the product.

96. The method of claim 21, further comprising:
associating a unique identifier that identifies the product with the created credit card account.
